(19) United States
(12) Patent Application Publication
(10) Pub. No.: US 2019/0373388 A1
(43) Pub. Date: Dec. 5, 2019

(54) Headphone Device

(71) Applicant: Meters Music Ltd., Essex (GB)

(72) Inventor: Mark Gooday, Essex (GB)

(21) Appl. No.: 16/247,632

(22) Filed: Jan. 15, 2019

Related U.S. Application Data
(63) Continuation of application No. 14/748,258, filed on Jun. 24, 2015, now abandoned.

(30) Foreign Application Priority Data
Sep. 25, 2014 (GB) 1416967.6
Apr. 28, 2015 (GB) 1507238.2

(51) Int. Cl. H04R 29/00; H04R 1/10

(52) U.S. Cl. CPC H04R 29/008; H04R 2460/01; H04R 1/1008; H04R 29/001

(57) ABSTRACT

Aspects described herein provide an apparatus that allows the user or a third party to easily monitor the volume levels of a set of headphones before and during use so as to prevent damage to the anatomy of the user's ears as a result of exposure to excessive noise volume. An analogue meter indicative of the signal level being input to or reproduced by the transducer within one or both of the headphone cans is provided, built into the outer surface of the headphone can so that it is easily visible to a user who is about to put on the headphones, or to a third party viewing the user wearing the headphones. The analogue meter is preferably indicative of sound pressure being generated by the transducer in the headphone can in which the meter is co-located, and may, for example, be a VU meter, or a PPM meter.

### CROSS-REFERENCE TO RELATED CASES

This application is a continuation of co-pending application Ser. No. 14/748,258, filed Jun. 24, 2015, entitled “A Headphone Device,” which in turn claims priority to GB application 1507238.2, filed Apr. 28, 2015, and 1416967.6, filed Sep. 25, 2014, each of the above being incorporated by reference in their entireties for all purposes.

### TECHNICAL FIELD

The present invention relates to the field of headphones. In particular, it relates to a headphone device with an integral and visible meter or meters, for example to indicate sound pressure level or volume level of the signal being reproduced by the headphones.

### BACKGROUND

Headphones as known in the art are typically a pair of sounder transducers arranged to be held in place over the ears of the user, which are then connected via a cable to a device with an audio output, for example, a personal media player, mobile phone, laptop, computer or any other electronic device capable of producing an audio signal. Such headphones typically comprise two substantially circular or oval cans containing the reproduction transducers, and that sit over the ears of the user in order to hold the transducers against or near to the ears, attenuating any external noise. In doing this, the user can clearly hear the audio output from the transducers and the quality of the audio signal is not impeded by surrounding sound. However, if the volume of the audio output is set at a high level, the close proximity of the transducers to the user's ears can result in harmful damage to the anatomy of the ear, for example, the ear drum, particularly if the high volume level is maintained for a prolonged period of time. In severe cases, this damage could be permanent.

Therefore, it is desirable that the user, or a third party, is able to monitor the volume level of the headphones before and during use. This may be achieved by providing some form of volume indicator device such as a volume unit (VU) meter which provides a display representative of signal level in audio devices. JP 2000197172 provides a headphone apparatus with a needle based analogue meter in line with the headphone cable, as illustrated in FIG. 1, which provides a visual indication of the volume level to the user. However, when the feed cable is connected to an audio device, this visual indication may become obscured from view and forgotten by the user. Moreover, if the volume level is being monitored by a third party, for example, an adult monitoring the headphones of a child or studio or stage technician monitoring the headphones of a musician, the third party may not necessarily be able to see the in-line meter, and hence would not be able to easily check the volume level without disturbing or distracting the user. Therefore, a solution is required that provides an easier and more accessible way of monitoring the volume levels of an audio signal being input to a headphones device.

Various other prior art is also known. For example, US2007/0291955 discloses a wireless headphone unit with a display unit that displays the sound volume. Similarly, KR20100007476U also describes a headset that has a display unit, that displays sound pressure level information obtained from a playback instrument.

### SUMMARY

Embodiments of the invention address the above noted problems by providing an apparatus that will allow the user or a third party to easily monitor the volume levels of a set of headphones before and during use so as to prevent damage to the anatomy of the user's ears as a result of prolonged exposure to excessive noise volume. In particular an analogue meter indicative of the signal level being input to or reproduced by the transducer within one or both of the headphone cans is provided, built into the outer surface of the headphone can so that it is easily visible to a user who is about to out on the headphones, or to a third party viewing the user wearing the headphones. The analogue meter is preferably indicative of sound pressure being generated by the transducer in the headphone can in which the meter is co-located, and may, for example, be a VU meter, or a PPM meter. By locating the meter within the body of the can co-located with the transducer, a compact and easy to view arrangement is obtained that is easier and safer to use than the prior art in-line arrangements.

From one aspect there is provided a headphone device, comprising one or more headphone cans, and preferably a pair of headphone cans connected by a connecting band, wherein at least one or more of the headphone cans comprise: a transducer for converting electrical signals to audio signals, the transducer being arranged to face internally towards the head of the user; and an analogue meter for providing a visual indication of the signal level being input to or reproduced by the transducer in the headphone can, the meter being arranged on the exterior of the headphone can such that it faces outwards.

In one embodiment the meter is a needle based analogue meter. The meter may be calibrated in volume units (VU), or alternatively the meter may be a PPM meter. In some embodiments the meter is illuminated for use in low ambient light conditions.

From another aspect, embodiments of the invention also provide a wearable sound reproducing device comprising one or more sound reproduction units arranged to be worn on or in the ears of a user, and one or more visual displays mounted so as to be co-located with the sound reproduction units and arranged to display a property of an audio signal being received at the wearable sound reproducing device.

In one embodiment the one or more visual displays comprise an analogue meter. Moreover, in embodiments of the invention the one or more visual displays may comprise any of a VU meter, a peak programme meter, or a sound pressure level (SPL) meter.

In some embodiments of the invention the audio signal is a signal being fed to the device for reproduction by the sound reproduction units. Thus, for example, the signal is a playback signal, being generated by a sound reproduction device such as a media player or the like.

In other embodiments the audio signal is an external signal incident on the device as part of the surrounding soundfield. In such arrangements one or more microphones may be provided to sample the surrounding soundfield to determine the external signal. This allows an indication of external sound levels to be provided to the user, for example in loud or noisy environments. In this respect, the headphones in such arrangements may be sound protecting headphones, so that the user is prompted by the display to the put the headphones on so as to protect their ears from a noisy or loud environment.

In a further development of such an embodiment, the device may further include noise cancellation circuitry arranged to operate in dependence on the external signal. This would then act to actively cancel the external noise or sound to further reduce the sound perceived by the user. Noise cancellation using anti-phase techniques is known in the art.

In one embodiment, the wearable sound reproducing unit is a pair of headphones having respective ear covering units in which are mounted the respective sound reproduction units for each ear, respective visual displays being mounted on an outward facing surface of the ear covering units so as to be visible to a third party other than the wearer when being worn. The respective visual displays may be oriented to face in any of a forwardly, side, or rearwardly direction with respect to the wearers head.

### BRIEF DESCRIPTION OF DRAWINGS

Embodiments of the present invention will now be described by way of example only, and with reference to the accompanying drawings in which:

FIGS. 1A-1C show headphones with a needle based analogue meter in line with the headphone feed cable, as known in the prior art;

FIG. 2 illustrates a headphone apparatus with a built in volume unit meter according to an illustrative embodiment of the present invention.

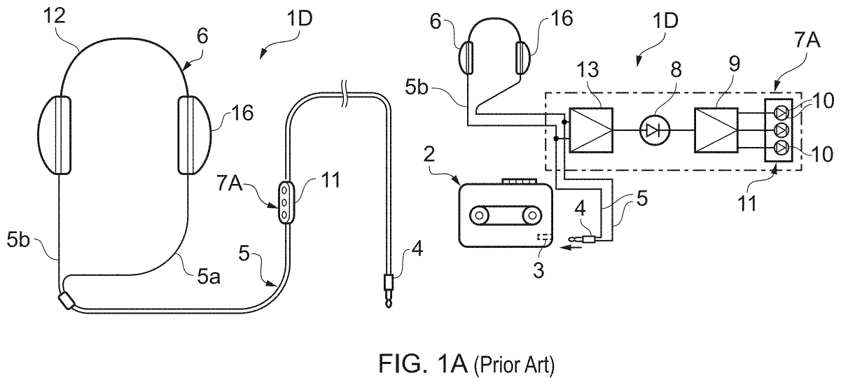

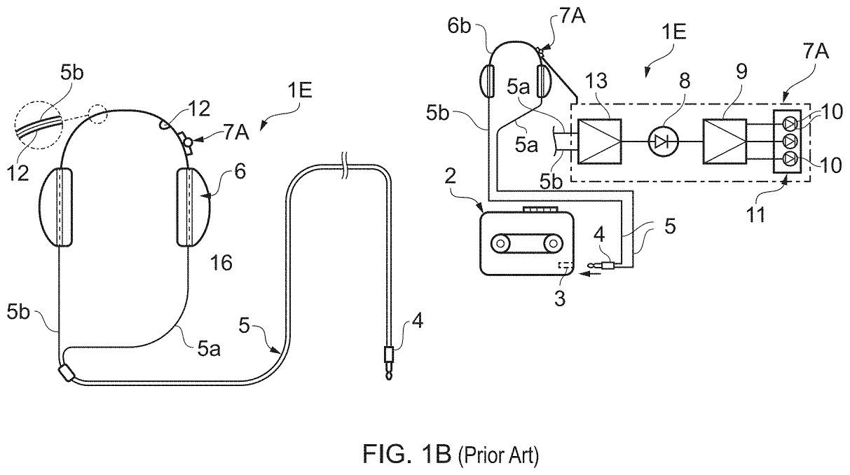

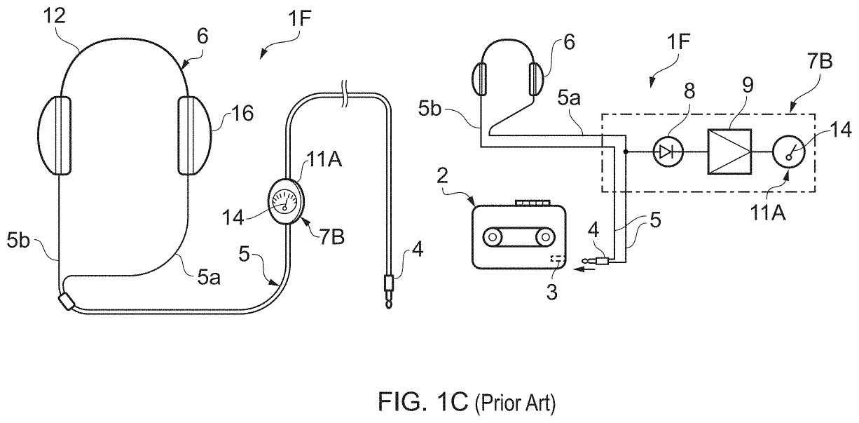

### DETAILED DESCRIPTION

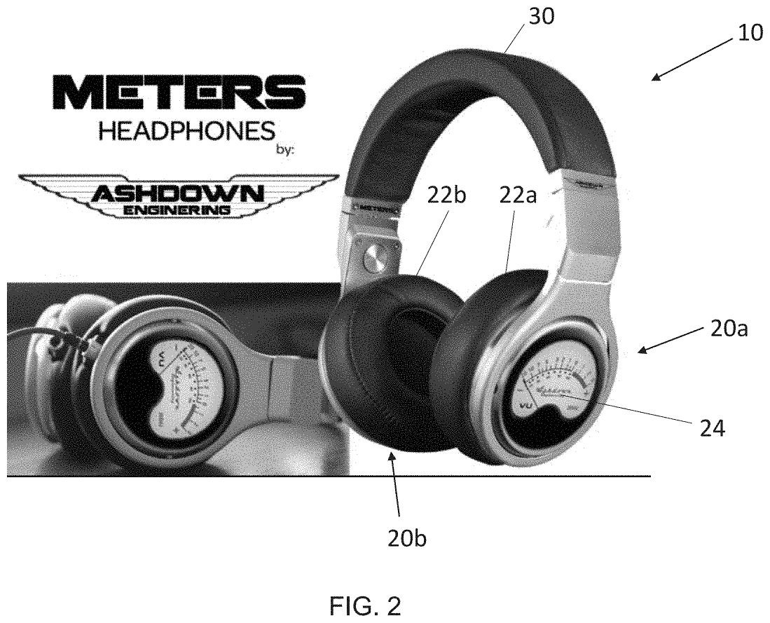

An embodiment of the present invention, as illustrated by way of example in FIG. 2, provides a set of headphones 10 consisting of respective first and second earphone cans 20a-b connected by an arm 30 configured to sit over the top of the user's head, holding each earphone can 20a-b over each ear. The first and second earphone cans 20a-b have respective pads 22a-b in which transducers (not shown) arranged to convert electric signals into an audio output are located. The pads 22a-b are configured so as to cover the user's ears in order to attenuate any external noise.

One or both earphone cans 20a-b further comprises a meter 24 (only one side shown) on the external side, wherein the meter 24 provides a visual indication of a property of the signal, such as the signal level, being fed into the transducers of the headphones. The meter 24 may be, for example, a volume unit (VU) meter, peak programme meter (PPM), or any other device calibrated to indicate the audio signal levels that the user is experiencing and capable of providing a visual representation thereof. In some embodiments, the meter 24 or meters will be illuminated to facilitate monitoring in conditions of low ambient light. VU meters and PPM meters are well known per se in the art. Where meters 24 are provided on both headphone cans, they preferably illustrate a property of the signal, such as the signal level, being fed to the respective can on which they are located.

With such an arrangement before putting on the headphones 10, the user is able to clearly and easily see what level of volume is being fed to the headphones. In addition, whilst the user is wearing the headphones, any third party can quickly and easily check the volume being input to the headphones without disrupting the user in any way or requiring them to remove the headphones. If the volume level is unsuitable, whether that be too loud or too quiet, in some embodiments it may then be adjusted externally. For example, a teacher may need to monitor the volume level of a child's headphones during a lesson without disrupting the child's learning experience. The teacher can simply check the outside of the child's headphones, and adjust the volume accordingly. In another example, a studio technician in a recording studio may want to monitor the volume level of a musician's headphones whilst the musician is performing. Using aspects described herein, the technician is able easily to see the headphone's volume level without stopping the performance or distracting the musician.

In addition, the signal level indication on the cans is also clearer for a user to see before he puts the headphones on, hence preventing possible ear damage by putting on headphones that are already in operation at too high a level.

Various modifications may be made to the above described embodiment to provide further embodiments. For example, in some variants the meter may be any kind of meter, such as an analogue meter, a digital display, or a mechanical display. In addition, in some variants the orientation of the meter 24 may be altered, for example it may face in any exterior direction, such as being forward facing or backward facing, or facings upwards or downwards, or any combination thereof, as an alternative to to facing out to the side, as shown previously.

Moreover, in some embodiments the measurement units may be different. For example, the meter may measure and display the sound in any of VU units, peak signal level units (using a PPM), or sound pressure level (SPL) units. The displayed units may be displayed by the unit on a linear scale, or logarithmically, for example as decibel (dB) versions of the unit (e.g. dB SPL).

In a further embodiment, instead of the meter representing the sound level of the signal being reproduced by the headphone transducers, instead the meter represents the sound level of the external ambient surroundings of the headphones. In this respect, in this embodiment the headphones include one or more small microphones, typically located on one or other, or both of the headphone cans, which are used to sample the surrounding soundfield external to the headphones. The signal(s) from the one or more microphones are then used to drive the meters, such that the meters display the sound level external to the headphones. Where microphones are provided on both headphone cans, then the respective microphones are used to drive the respective meters on the same can on which the microphone is mounted. Alternatively, where a single microphone is provided, then the single signal therefrom may be used to drive one or other or both of the meters on the respective headphone cans. Where both are driven by the same signal then the respective meters would typically display the same signal.

Such an arrangement is useful in situations where there may be high levels of external sound, such as at concert venues, race tracks, or other situations in which high sound levels are produced. The meters display the external sound level and hence can be monitored by the user. When the sound level reaches a level which the user considers loud (and which may also be indicated by appropriately placed markings on the meter) then the user can put on the headphones (on either himself, or a third person, such as for example an accompanying child) to reduce the amount of sound energy reaching the ears of the wearer.

In addition, in a further embodiment the headphones can be arranged to be active noise cancelling headphones, to further reduce the perceived sound levels, using conventional noise cancelling technology, as is known in the art. Such an embodiment provides additional noise protection, by actively reducing the perceived noise using anti-phase techniques.

As another modification to provide further embodiments, the meter itself is the luminaire that provides light for illumination purposes. Such an arrangement has advantages that no other light source is required. In other embodiments, however, a separate light source for the meter, such as LEDs, or bulbs, may be provided.

Whilst in the embodiment shown the headphones there comprise two headphone cans connected by a band, it should be understood that such an arrangement is not essential, and that earphone type arrangements are also envisaged, which are not connected by a band. By the term “headphone can”, therefore, we also intend to encompass earphone arrangements that have sufficient external area on which the meter may be mounted.

Various further modifications, whether by way of addition, deletion or substitution may be made to the above described embodiments to provide further embodiments, any and all of which are intended to be encompassed by the appended claims.

1. A headphone device, comprising:
a pair of headphone cans, each headphone can comprising a generally cup-shaped can body, the can body having a concave configuration such that a cavity is defined, the cavity being enclosed by a user contacting portion, wherein the user contacting portion is arranged in use to face internally towards the head of the user such that it presses against or sits around the ear of the user; and
a connecting band for connecting the pair of headphone cans, each headphone can being mounted to an end of the connecting band such that the user contacting portion of one headphone can is facing the user contacting portion of the other headphone can, wherein the connecting band is arranged in use to sit around the head of the user such that the headphone cans are aligned with the ears of the user,
wherein at least one or more of the headphone cans comprise:
a transducer for converting electrical signals to audio signals, the transducer being disposed within the cavity of the can body and arranged to face internally towards the head of the user such that in use the audio signals are directed towards the ear of the user; and
a needle based volume unit (VU) meter for providing a visual indication of a signal level of the audio signal being reproduced by the transducer in the headphone can, the meter comprising a movable needle and a scale, the scale having units representative of the signal level of the audio signal, wherein the units of the scale are volume units (VU),
wherein the meter is calibrated such that the sensitivity of the moveable needle to the signal level of the audio signal being reproduced by the transducer corresponds to the units of the scale, and wherein the meter is arranged on the exterior of the headphone can such that it faces outwards so as to be visible to a third party other than the wearer when being worn.

2. A device according to claim 1, further comprising a light source to illuminate the meter for use in low ambient light conditions.

3. A device according to claim 1, wherein the device comprises one or more microphones to sample the surrounding soundfield to determine an external signal incident on the device.

4. A device according to claim 3, and further comprising noise cancellation circuitry arranged to operate in dependence on the external signal.

5. A device according to claim 1, wherein the respective meters are oriented to face in any of a forwardly, side, or rearwardly direction with respect to the wearers head.

6. A device according to claim 3, wherein the needle based volume unit (VU) meter is further arranged to provide an indication of a property of the external signal determined by the one or more microphones.

7. A device according to claim 6, wherein the property is the sound level of the surrounding soundfield.

8. A wearable sound reproducing device comprising one or more sound reproduction units arranged to be worn on or in the ears of a user, wherein an audio signal is being fed to the device for reproduction by the sound reproduction units, and one or more visual displays mounted so as to be co-located with the sound reproduction units and arranged to display a signal level of the audio signal being reproduced by the sound reproduction units, wherein the one or more visual displays comprise a needle based volume unit (VU) meter, the meter comprising a movable needle and a scale, the scale having units representative of the signal level of the audio signal being reproduced by the sound reproduction units, wherein the units of the scale are volume units (VU), and wherein the meter is calibrated such that the sensitivity of the moveable needle to the signal level of the audio signal being reproduced by the sound reproduction units corresponds to the units of the scale.

9. A device according to claim 8, further comprising a light source to illuminate the meter for use in low ambient light conditions.

10. A device according to claim 8, wherein the device comprises one or more microphones to sample the surrounding soundfield to determine an external signal incident on the device.

11. A device according to claim 10, and further comprising noise cancellation circuitry arranged to operate in dependence on the external signal.

12. A device according to claim 10, wherein the needle based volume unit (VU) meter is further arranged to provide an indication of a property of the external signal determined by the one or more microphones.

13. A device according to claim 12, wherein the property is the sound level of the surrounding soundfield.

14. A device according to claim 10, wherein the wearable sound reproducing unit is a pair of headphones having respective ear covering units in which are mounted the respective sound reproduction units for each ear, respective visual displays being mounted on an outward facing surface of the ear covering units so as to be visible to a third party other than the wearer when being worn.
